(19) United States
(12) Patent Application Publication
(10) Pub. No.: US 2023/0300882 A1
(43) Pub. Date: Sep. 21, 2023

(54) METHOD AND APPARATUS FOR UPLINK CHANNEL ACCESS

(71) Applicant: LENOVO (BEIJING) LIMITED, Beijing (CN)

(72) Inventor: Haipeng LEI, Beijing (CN)

(21) Appl. No.: 18/040,915

(22) PCT Filed: Aug. 7, 2020
(86) PCT No.: PCT/CN2020/107803

§ 371 Date: Feb. 7, 2023

(51) Int. Cl. H04W 74/08; H04W 52/14; H04W 52/22

(52) U.S. Cl. CPC H04W 74/0808; H04W 52/146; H04W 52/228

(57) ABSTRACT

Embodiments of the present disclosure relate to methods and apparatuses. According to some embodiments of the disclosure, a method for wireless communications performed by a UE may include: determining a first energy detection threshold for performing a channel access procedure; and performing the channel access procedure based on the first energy detection threshold.

### TECHNICAL FIELD

Embodiments of the present disclosure generally relate to wireless communication technology, and more particularly to uplink channel access.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) or a base station (BS) may operate in both a licensed spectrum and an unlicensed spectrum. For a transmission on an unlicensed spectrum, in order to achieve fair coexistence between wireless systems, a channel access procedure (e.g., a listen-before-talk (LBT) procedure) may be required before transmission on the unlicensed spectrum. In the LBT procedure, a UE or a BS may perform energy detection on a certain channel. If the detected energy is lower than a predefined threshold, the channel is deemed as empty and available for transmission, and then the LBT procedure is successful. Only when the LBT procedure is successful can the UE or the BS start transmission on the channel and occupy the channel a certain channel occupancy time (COT), which is less than a maximum channel occupancy time (MCOT). Otherwise, the UE or the BS cannot start the transmission and may continue to perform another LBT procedure until a successful LBT procedure.

There is a need for handling uplink channel access on an unlicensed spectrum. For example, solutions that can improve the channel access probability so as to enhance the transmission on the unlicensed spectrum are desired.

### SUMMARY

Some embodiments of the present disclosure provide a method for wireless communications performed by a user equipment (UE). The method may include: determining a first energy detection threshold for performing a channel access procedure; and performing the channel access procedure based on the first energy detection threshold.

Some embodiments of the present disclosure provide a method for wireless communications performed by a base station (BS). The method may include: determining an energy detection threshold for performing a channel access procedure, wherein the energy detection threshold is determined from a plurality of energy detection thresholds based on a traffic type of a downlink transmission; and performing the channel access procedure based on the determined energy detection threshold.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary procedure for wireless communications in accordance with some embodiments of the present disclosure;

FIG. 3 illustrates a flow chart of an exemplary procedure for wireless communications in accordance with some embodiments of the present disclosure;

FIG. 4 illustrates a flow chart of an exemplary procedure for determining an energy detection threshold in accordance with some embodiments of the present disclosure;

FIG. 5 illustrates a flow chart of an exemplary procedure for determining an energy detection threshold in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

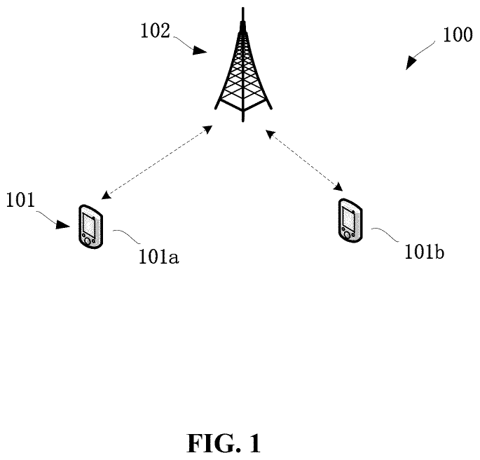

FIG. 1 illustrates a schematic diagram of a wireless communication system 100 in accordance with some embodiments of the present disclosure.

As shown in FIG. 1, a wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs 101 and BSs 102 may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with BSs 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BS 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with the 5G NR of the 3GPP protocol. For example, BS 102 may transmit data using an OFDM modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums (e.g., at around 6 GHz or 60 GHz of carrier frequency). The present disclosure is not intended to be limited to the implementation of any particular wireless communication system architecture or protocol.

For a transmission on an unlicensed spectrum, in order to achieve fair coexistence between wireless systems (e.g., NR system access on unlicensed spectrum (NR-U) systems and other wireless systems), a channel access procedure, also known as a listen-before-talk (LBT) test or LBT procedure, may be performed before communicating on the unlicensed spectrum.

The channel access procedure may be performed based on sensing (or energy detection) that evaluates the availability of a channel for performing transmissions. The basic unit for sensing is a sensing slot. In some examples, the sensing slot may have the duration of Tₛₗ=9 us. When a BS or a UE senses a channel during a sensing slot duration Tₛₗ, and determines that the detected energy for at least a certain period of time (e.g., 4 us) within the sensing slot duration is less than an energy detection threshold (x_{Thresh}), the sensing slot duration Tₛₗ may be considered as idle and so the channel may be deemed as empty or clear or available in the sensing slot. Otherwise, the sensing slot duration Tₛₗ may be considered as busy, and so the channel may be deemed as occupied or non-available in the sensing slot.

In NR-U systems, when a BS or a UE intends to initiate a channel occupancy time (COT) for DL or UL transmission, a Type 1 DL or UL channel access procedure, also known as “LBT Category 4 procedure” or “LBT Cat. 4 procedure,” may be performed. In response to a successful Type 1 DL or UL channel access procedure, the BS or UE can start a transmission on the channel and occupy the channel up to a maximum channel occupancy time (MCOT). Otherwise, the BS or UE cannot start the transmission and may continue to perform another LBT procedure until a successful LBT procedure.

For a physical uplink shared channel (PUSCH) transmission in a resource scheduled by a UL grant, in the case of a dynamic channel access mode, a detailed UL channel access type (e.g., Type 1 UL channel access procedure or Type 2A/2B/2C UL channel access procedure) may be indicated in the UL grant. On the other hand, in the case of a semi-static channel access mode (e.g., frame-based equipment (FBE) mode), there is no such UL channel access type indication. This is because in the latter case, a UE may only sense a channel for at least a sensing slot duration Tₛₗ=9 us within a 25 us interval, which is ended immediately before the transmission. Only when the channel access is successful can the UE start the PUSCH transmission in the resource. Otherwise, the UE has to abandon or drop the PUSCH transmission in the resource.

For a physical uplink control channel (PUCCH) transmission in a resource scheduled by a DL assignment, in the case of a dynamic channel access mode, a detailed UL channel access type, (e.g., Type 1 UL channel access procedure or Type 2A/2B/2C UL channel access procedure) may be indicated in the DL assignment. On the other hand, in the case of a semi-static channel access mode (e.g., frame-based equipment (FBE) mode), there is no such UL channel access type indication. This is because in the latter case, a UE may only sense the channel for at least a sensing slot duration Tₛₗ=9 us within a 25 us interval, which is ended immediately before the transmission. Only when the channel access is successful can the UE start the PUCCH transmission in the resource. Otherwise, the UE has to abandon or drop the PUCCH transmission in the resource.

In some circumstances, either a Type 1 UL channel access procedure or Type 2A/2B UL channel access procedure may fail when, for example, the channel is occupied by other wireless systems or other nodes (e.g., UEs). In this scenario, the corresponding UL transmission shall be abandoned or dropped due to the channel access failure.

However, services (e.g., ultra-reliable low latency communications (URLLC) service) supported on the unlicensed spectrum may require short latency and/or ultra-reliability. A UE may be scheduled to transmit, for example, a PUSCH carrying urgent UL traffic or a PUCCH carrying hybrid automatic repeat request acknowledgement (HARQ-ACK) feedback for urgent DL traffic. When a channel access for the PUSCH or PUCCH fails, the BS may be unable to detect the PUSCH or PUCCH in the scheduled resource. As a result, the BS has to retransmit another UL grant for scheduling the retransmission of the urgent UL traffic, or another DL assignment for scheduling the retransmission of a PDSCH carrying urgent DL traffic or requesting the retransmission of the HARQ-ACK feedback for the urgent DL traffic using enhanced Type 2 HARQ-ACK codebook determination. In this scenario, the requirements on short latency and/or ultra-reliability of the urgent DL or UL traffic may be quite difficult to be satisfied.

Embodiments of present disclosure provide solutions to improve UL channel access probability and to enhance the UL transmission over the unlicensed spectrum. More details on the embodiments of the present disclosure will be illustrated in the following text in combination with the appended drawings.

A UE accessing a channel on which a UL transmission(s) is performed may set the energy detection threshold (X_{Thresh}) for performing sensing to be less than or equal to a maximum energy detection threshold (X_{Thresh_max}).

In some embodiments of the present disclosure, the maximum energy detection threshold may be configured by a BS through higher layer signaling (e.g., radio resource control (RRC) signaling). For example, when a corresponding higher layer parameter (e.g., maxEnergyDetectionThreshold-r14 or maxEnergyDetectionThreshold-r16) is configured, the maximum energy detection threshold may be set to equal the corresponding value signaled by the higher layer parameter.

In some embodiments of the present disclosure, a UE may determine the maximum energy detection threshold. When a corresponding higher layer parameter (e.g., energyDetectionThresholdOffset-r14 or energyDetectionThresholdOffset-r16) is configured, the maximum energy detection threshold (X_{Thresh_max}) may be set by adjusting X′_{Thresh_max} according to the offset value signaled by the higher layer parameter. Otherwise, X_{Thresh_max}=X′_{Thresh_max}.

In some embodiments of the present disclosure, a UE may determine X′_{Thresh_max} based on regulatory requirements or transmit power values. For example, when a corresponding higher layer parameter (e.g., absenceOfAnyOtherTechnology-r14 or absenceOfAnyOtherTechnology-r16) is configured, a UE may determine X′_{Thresh_max} based on the following equation:

$${X}_{Thresh \_ max}^{′} = min \{ \begin{matrix}{T}_{max} + 10 dB \\ {X}_{r}\end{matrix} \} \qquad ( 1 )$$

In the above equation (1), Xᵣ is the maximum energy detection threshold defined by regulatory requirements in units of dBm when such requirements are defined; otherwise Xᵣ=Tₘₐₓ+10 dB. Tₘₐₓ may be in units of dBm, and may be determined by Tₘₐₓ(dBm)=10·log 10(3.16228·10⁻⁸ (mW/MHz)·BWMHz (MHz)), wherein BWMHz is the single channel bandwidth in units of MHz.

Otherwise, when the above higher layer parameter (e.g., absenceOfAnyOtherTechnology-r14 or absenceOfAnyOtherTechnology-r16) is not configured, a UE may determine X′_{Thresh_max} based on the following equation:

$${X}_{Thresh \_ max}^{′} = \qquad ( 2 )$$

$$max \{ \begin{matrix}- 72 + 10 \cdot log 10 ( BWMHz / 20 MHz ) dBm , \\ min \{ \begin{matrix}{T}_{max} , \\ {T}_{max} - {T}_{A} + ( {P}_{H} + 10 \cdot log 10 ( BWMHz / 20 mHz ) - {P}_{TX} )\end{matrix} \}\end{matrix} \}$$

In the above equation (2), T_{A}=10 dB, P_{H}=23 dBm, and Tₘₐₓ has the same meaning as mentioned above (e.g., Tₘₐₓ(dBm)=10·log 10(3.16228·10⁻⁸ (mW/MHz)·BWMHz (MHz)), wherein BWMHz is the single channel bandwidth in units of MHz). In some embodiments of the present disclosure, P_{TX} denotes the transmit power of a UE, and may be set to the value of P_{CMAX_H,c}, which indicates the maximum transmit power of the UE.

In some embodiments of the present disclosure, for a UL transmission (e.g., PUSCH or PUCCH transmission) on an unlicensed spectrum, RRC signaling may be employed to configure a plurality of sets of uplink power control parameters (e.g., {P0, alpha}, where P0 relates to the target signal to noise ratio (SNR) and alpha denotes a factor to compensate the pathloss between the BS and the UE) for a UE. In some embodiments of the present disclosure, the plurality of sets of uplink power control parameters may be predefined, for example, in standard.

The UE may support services that require short latency and/or ultra-reliability (e.g., enhanced mobile broadband (eMBB) service and URLLC service). Different services may correspond to different traffic types, i.e., different types of user plane data. In some examples, at least one set of uplink power control parameters of the plurality of sets of uplink power control parameters may be configured for traffic type #1 (e.g., eMBB service), and at least two sets of uplink power control parameters of the plurality of sets of uplink power control parameters may be configured for traffic type #2 (e.g., URLLC service).

In some embodiments, the set of uplink power control parameters configured for traffic type #1 can be also configured for traffic type #2. For example, uplink power control parameter set #1 may be configured for traffic types #1 and #2, and uplink power control parameter set #2 may be configured for traffic type #2 only. In this case, uplink power control parameter set #2 may be used to derive a lower transmit power than the uplink power control parameter set #1.

The UE may determine a plurality of energy detection thresholds based on the plurality of sets of uplink power control parameters. In some examples, there may be a one-to-one mapping relation between a set of uplink power control parameters to an energy detection threshold. The lower the UL transmit power, the higher the energy detection threshold for the UL channel access.

In some embodiments of the present disclosure, during a UL channel access procedure, a UE may determine an energy detection threshold based on equation (2) as described above. In these embodiments, the UE may set the value of P_{TX} in equation (2) according to certain principles. For example, in some embodiments, for traffics of different types, the UE may determine the values of P_{TX} according to different methods.

For example, for traffic type #1 (e.g., eMBB traffic), in some examples, the value of P_{TX} may be set to the maximum transmit power of the UE. In some other examples, the value of P_{TX} may be set to a UL transmit power determined based on the at least one set of uplink power control parameters configured for traffic type #1. In some instances, only one set of uplink power control parameters may be configured for traffic type #1.

For traffic type #2 (e.g., URLLC traffic), in some examples, the value of P_{TX} may be set to the UL transmit power determined based on the at least two sets of uplink power control parameters configured for traffic type #2.

For example, assuming that N sets of uplink power control parameters are configured or predefined for URLLC traffic, the UE may determine N uplink transmit powers (P₀, P₁, . . . , P_{N-1}) associated with the N sets of uplink power control parameters. The UE may set a respective one of N uplink transmit powers as the value of P_{TX} in equation (2), and may obtain N energy detection thresholds (e.g., X₀, X₁, . . . , X_{N-1}). Assuming that P₀<P₁<, . . . , <P_{N-1}, then X₀>X₁, . . . , >X_{N-1}.

In some embodiments, when performing the UL channel access, the UE may firstly use the highest energy detection threshold (e.g., X₀) to perform a channel access procedure, and may compare the received power on the channel (e.g., the energy detected on the channel) with X₀. If the received power is greater than X₀, which suggests a failed channel access procedure, the UE may abandon or suspend the uplink transmission (e.g., PUSCH or PUCCH transmission). Otherwise, if the received power is less than X₀, the UE may compare the received power with the next lower energy detection threshold (e.g., X₁) in descending order to find out the minimum energy detection threshold which is greater than the received power. After finding such energy detection threshold (e.g., Xᵢ, where i may be one of 1 to N−1), UE may use an uplink transmit power (e.g., Pᵢ) corresponding to this energy detection threshold (e.g., Xᵢ) for the uplink transmission (e.g., PUSCH or PUCCH transmission).

In some embodiments, when performing the UL channel access, the UE may firstly use the lowest energy detection threshold (e.g., X_{N-1}) to perform a channel access procedure, and may compare the received power on the channel with X_{N-1}. If the received power is lower than X_{N-1}, which suggests a successful channel access procedure, the UE may use an uplink transmit power (e.g., P_{N-1}) corresponding to this energy detection threshold (e.g., X_{N-1}) for the uplink transmission (e.g., PUSCH or PUCCH transmission). Otherwise, if the received power is greater than X_{N-1}, the UE may compare the received power with the next energy higher detection threshold (e.g., X_{N-2}) in ascending order to find out the minimum energy detection threshold which is greater than the received power. After finding such energy detection threshold (e.g., Xⱼ, where j may be one of 1 to N−1), UE may use an uplink transmit power (e.g., Pⱼ) corresponding to this energy detection threshold (e.g., Xⱼ) for the uplink transmission (e.g., PUSCH or PUCCH transmission).

In some other embodiments of the present disclosure, for a UL transmission (e.g., PUSCH or PUCCH transmission) on an unlicensed spectrum, RRC signaling may be employed to configure a plurality of energy detection thresholds. In some embodiments of the present disclosure, the plurality of energy detection thresholds may be predefined, for example, in standard.

The energy detection threshold may be configured per UE and per service. For example, at least one energy detection threshold of the plurality of energy detection thresholds may be configured for traffic type #1 (e.g., eMBB service), and at least one energy detection threshold of the plurality of energy detection thresholds may be configured for traffic type #2 (e.g., URLLC service). In some examples, the energy detection threshold for URLLC traffic may be the same as that for eMBB traffic. In some other examples, the energy detection threshold for URLLC traffic may be higher than that for eMBB traffic, so as to improve the channel accessing probability for URLLC service.

In some embodiments of the present disclosure, the energy detection threshold may be configured in an absolute manner. For example, the plurality of energy detection threshold may be configured in units of dBm with a step size of, for example, 1 dBm. For example, the plurality of energy detection threshold may be {20 dBm, 21 dBm, 22 dBm, 23 dBm}.

In some other embodiments of the present disclosure, the plurality of energy detection thresholds may be determined based on a plurality of offsets with respect to a default energy detection threshold. The default energy detection threshold may be calculated based on the above equation (2), wherein the value of P_{TX} is set to the maximum transmit power of the UE. The plurality of offsets may be configured to the UE via an RRC message or may be predefined, for example, in standard. The plurality of offsets may be in units of dB with a step size of, for example, 1 dB.

In the context of the subject disclosure, using a specific energy detection threshold to perform a channel access procedure or performing a channel access procedure based on a specific energy detection threshold refers to performing the channel access procedure using an energy detection threshold less than or equal to the specific energy detection threshold.

For instance, in some cases, when a UE determine an energy detection threshold based on, for example, the methods described above and below, the UE may set the energy detection threshold (X_{Thresh}) for performing sensing to be less than or equal to the determined energy detection threshold when accessing a channel on which a UL transmission(s) is performed. That is, in these cases, the determined energy detection threshold is the maximum energy detection threshold. In some other cases, the UE may use the determined energy detection threshold as the energy detection threshold (X_{Thresh}) for performing sensing. That is, in these cases, the determined energy detection threshold is the energy detection threshold (X_{Thresh}) for performing sensing.

In some other embodiments of the present disclosure, for a UL transmission (e.g., PUSCH or PUCCH transmission) on an unlicensed spectrum, RRC signaling may be employed to configure a plurality of energy detection thresholds. In some embodiments of the present disclosure, the plurality of energy detection thresholds may be predefined, for example, in standard.

Downlink control information (DCI) may include an indicator indicating a specific energy detection threshold from the plurality of energy detection thresholds to the UE for performing the channel access. In this way, the BS can adjust the energy detection threshold based on traffic. Assuming that the plurality of energy detection thresholds configured to a UE are {Y₀, Y₁, . . . , Y_{M-1}}, in a DCI, the number of bits of the indicator in the DCI may be equal to or greater than ┌log₂ M┐, where ┌ ┐ is the ceiling function.

For PUCCH transmission carrying HARQ-ACK feedback for DL URLLC traffic, the DCI scheduling the PDSCH carrying the DL URLLC traffic may indicate a relatively higher energy detection threshold to the UE. For PUSCH transmission carrying UL URLLC traffic, the DCI scheduling the PUSCH carrying the UL URLLC traffic may indicate a relatively higher energy detection threshold to the UE. As a general principle, the more urgent the traffic to be acknowledged or scheduled, the higher the energy detection threshold indicated to the UE. Under such principle, for PUCCH transmission carrying HARQ-ACK feedback for DL eMBB traffic, the DCI scheduling the PDSCH carrying the DL eMBB traffic may indicate a relatively lower energy detection threshold to the UE. Similarly, for PUSCH transmission carrying UL eMBB traffic, the DCI scheduling the PUSCH carrying the UL eMBB traffic may indicate a relatively lower energy detection threshold to the UE. Correspondingly, the indicated energy detection threshold may be also used by the UE to determine the UL transmit power for transmitting the PUSCH or PUCCH.

In some embodiments of the present disclosure, the plurality of energy detection thresholds may be configured in an absolute manner. For example, the plurality of energy detection threshold may be configured in units of dBm with a step size of, for example, 1 dBm.

In some other embodiments of the present disclosure, the plurality of energy detection thresholds may be determined based on a plurality of offsets with respect to a default energy detection threshold. The default energy detection threshold may be calculated based on the above equation (2), wherein the value of P_{TX} is set to the maximum transmit power of the UE. The plurality of offsets may be configured to the UE via an RRC message or may be predefined, for example, in standard. The plurality of offsets may be in units of dB with a step size of, for example, 1 dB.

In some embodiments of the present disclosure, for a UL transmission (e.g., PUSCH or PUCCH transmission) on an unlicensed spectrum, RRC signaling may be employed to configure a plurality of sets of uplink power control parameters (e.g., {P0, alpha}) for a UE. In some embodiments of the present disclosure, the plurality of sets of uplink power control parameters may be predefined, for example, in standard.

Downlink control information (DCI) may include an indicator indicating a specific set of uplink power control parameters from the plurality of sets of uplink power control parameters. The specific set of uplink power control parameters may be used by the UE to calculate an uplink transmit power and determine an energy detection threshold for performing the channel access. In this way, the BS can adjust the energy detection threshold based on traffic, via the uplink power control parameter set. Assuming that K sets of uplink power control parameters are configured, in a DCI, the number of bits of the indicator in the DCI may be equal to or greater than ┌log₂ K┐, where ┌ ┐ is the ceiling function.

For PUCCH transmission carrying HARQ-ACK feedback for DL URLLC traffic, the DCI scheduling the PDSCH carrying the DL URLLC traffic may indicate a relatively lower uplink power control parameter set, which corresponds to a relatively higher energy detection threshold, to the UE. Similarly, for PUSCH transmission carrying UL URLLC traffic, the DCI scheduling the PUSCH carrying the UL URLLC traffic may indicate a relatively lower uplink power control parameter set, which corresponds to a relatively higher energy detection threshold, to the UE. As a general principle, the more urgent the traffic to be acknowledged or scheduled, the lower the uplink power control parameter set (that is, the higher the energy detection threshold) indicated to the UE. Under such principle, for PUCCH transmission carrying HARQ-ACK feedback for DL eMBB traffic, the DCI scheduling the PDSCH carrying the DL eMBB traffic may indicate a relatively higher uplink power control parameter set, which corresponds to a relatively lower energy detection threshold, to the UE. Similarly, for PUSCH transmission carrying UL eMBB traffic, the DCI scheduling the PUSCH carrying the UL eMBB traffic may indicate a relatively higher uplink power control parameter set, which corresponds to a relatively lower energy detection threshold, to the UE.

The above methods can be similarly applied to a DL transmission(s) on an unlicensed spectrum. For example, in some embodiments of the present disclosure, for a DL transmission (e.g., physical downlink shared channel (PDSCH) or physical downlink control channel (PDCCH) transmission) on an unlicensed spectrum, a plurality of energy detection thresholds may be predefined, for example, in standards, at a BS. The BS may support services that require short latency and/or ultra-reliability (e.g., eMBB service and URLLC service). The energy detection threshold may be predefined per service.

For example, at least one energy detection threshold of the plurality of energy detection thresholds may be predefined for traffic type #1 (e.g., eMBB service), and at least one energy detection threshold of the plurality of energy detection thresholds may be predefined for traffic type #2 (e.g., URLLC service). In some examples, the energy detection threshold for URLLC traffic may be the same as that for eMBB traffic. In some other examples, the energy detection threshold for URLLC traffic may be higher than that for eMBB traffic, so as to improve the channel accessing probability for URLLC service. Correspondingly, the predefined energy detection threshold may be also used by the BS to determine the DL transmit power for transmitting the PDSCH or PDCCH.

In some embodiments of the present disclosure, the energy detection threshold for a BS may be predefined in an absolute manner. For example, the plurality of energy detection threshold may be predefined in units of dBm with a step size of, for example, 1 dBm. For example, the plurality of energy detection threshold may be {43 dBm, 44 dBm, 45 dBm, 46 dBm}.

In some other embodiments of the present disclosure, instead of predefining absolute values of the energy detection threshold, relative values (e.g., a plurality of offsets) may be predefined. For example, the plurality of energy detection thresholds may be determined based on a plurality of offsets with respect to a default energy detection threshold. The default energy detection threshold may be calculated based on the above equation (2), wherein the value of PTX is set to the maximum transmit power of the BS. The plurality of offsets may be predefined, for example, in standard. The plurality of offsets may be in units of dB with a step size of, for example, 1 dB.

By adopting the above methods, a UL transmission (e.g., PUSCH and PUCCH) can be transmitted to a BS and a DL transmission (e.g., PDSCH and PDCCH) can be transmitted to a UE with higher accessing probability on the unlicensed spectrum.

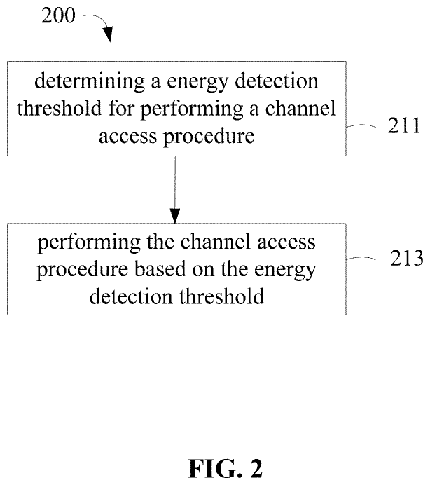

FIG. 2 illustrates a flow chart of an exemplary procedure 200 for wireless communications in accordance with some embodiments of the present disclosure. Details described in all of the foregoing embodiments of the present disclosure are applicable for the embodiments shown in FIG. 2. The procedure may be performed by a UE, for example, UE 101 in FIG. 1.

Referring to FIG. 2, in operation 211, a UE may determine an energy detection threshold for performing a channel access procedure. In operation 213, the UE may perform the channel access procedure based on the energy detection threshold (hereinafter referred to as “the first energy detection threshold” for illustration).

In some embodiments of the present disclosure, the UE may determine the first energy detection threshold according to the following method.

The UE may determine a transmit power (hereinafter referred to as “the first transmit power” for illustration) for an uplink transmission (e.g., PUSCH or PUCCH). The first energy detection threshold may be determined based on the first transmit power. The first transmit power may be determined based on a set of uplink power control parameters (hereinafter referred to as “the first set of uplink power control parameters” for illustration) selected from a plurality of sets of uplink power control parameters. The first set of uplink power control parameters may be selected based on certain criteria, for example, a traffic type (e.g., eMBB or URLLC traffic) of the uplink transmission.

In some embodiments of the present disclosure, the plurality of sets of uplink power control parameters may be configured by an RRC message from a BS. In some embodiments of the present disclosure, the plurality of sets of uplink power control parameters may be predefined. Each of the plurality of sets of uplink power control parameters may be associated with a corresponding transmit power.

In some embodiments of the present disclosure, the first transmit power is the highest one among the corresponding transmit powers of the plurality of sets of uplink power control parameters. The UE may transmit the uplink transmission using the first transmit power in response to the channel access procedure being successful.

In response to the channel access procedure being failed (e.g., an energy detected during the channel access procedure is greater than or equal to the first energy detection threshold), the UE may select another set of uplink power control parameters (hereinafter referred to as “the second set of uplink power control parameters” for illustration) from the plurality of sets of uplink power control parameters. The UE may determine another transmit power (hereinafter referred to as “the second transmit power” for illustration) based on the second set of uplink power control parameters. The second transmit power is lower than the first transmit power. The UE may determine another energy detection threshold (hereinafter referred to as “the second energy detection threshold” for illustration) based on the second transmit power. The UE may transmit the uplink transmission using the second transmit power in response to the second energy detection threshold is greater than the energy detected during the channel access procedure.

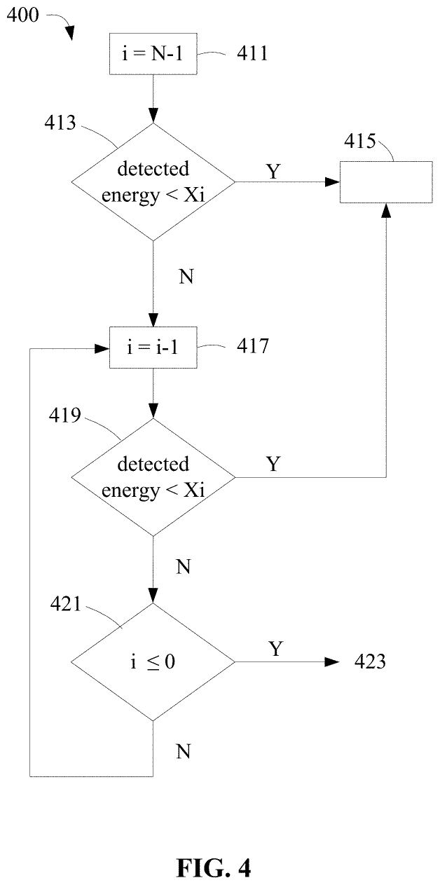

FIG. 4 illustrates a flow chart of an exemplary procedure 400 for determining an energy detection threshold in accordance with some embodiments of the present disclosure.

Assuming that N sets of uplink power control parameters are configured or predefined for a specific traffic type (e.g., URLLC traffic) at the UE, the UE may determine N uplink transmit powers (P₀, P₁, . . . , P_{N-1}) associated with the N sets of uplink power control parameters. Using the above-mentioned equation (2), the UE may obtain N energy detection thresholds (e.g., X₀, X₁, . . . , X_{N-1}). Assuming that P₀<P₁<, . . . , <P_{N-1}, then X₀>X₁>, . . . , >X_{N-1}.

The UE may perform a channel access procedure based on energy detection threshold Xᵢ, wherein i may be one of 1 to N−1. Referring to FIG. 4, in operation 411, the value of i may be set to N−1. That is, the UE may perform a channel access procedure based on energy detection threshold X_{N-1}, which is the lowest energy detection threshold among the N energy detection thresholds and correspond to the highest transmit powers P_{N-1} among the N uplink transmit powers.

In operation 413, the UE may determine whether the energy detected during the channel access procedure is less than the energy detection threshold Xᵢ (at this moment, i=N−1). In response to the detected energy is less than the energy detection threshold Xᵢ, which means a successful channel access procedure, the UE may transmit the uplink transmission using a corresponding transmit power (e.g., Pᵢ=P_{N-1}) in operation 415.

In response to the detected energy is greater than or equal to the energy detection threshold Xᵢ, which means a failed channel access procedure, the UE may try to find another energy detection threshold which is greater than the detected energy. For example, in operation 417, the UE may set i=i−1. The UE may, in operation 419, determine whether the detected energy is less than the energy detection threshold Xᵢ. In response to the detected energy is less than the energy detection threshold Xᵢ, the procedure may go to operation 415. In operation 415, the UE may transmit the uplink transmission using a corresponding transmit power (e.g., Pᵢ).

In response to the detected energy is greater than or equal to the energy detection threshold Xᵢ, the UE may determine whether all of the N energy detection thresholds are tested. For example, in operation 421, the UE may determine whether the value of i is equal to or less than 0. In response to the value of i is greater than 0, the procedure may go to operation 417. In response to the value of i is equal to or less than 0, the procedure may go to operation 423. In operation 423, the UE may abandon the uplink transmission.

As mentioned above, the principle of the above procedure is to find out the minimum energy detection threshold which is greater than the detected energy from the plurality of energy detection threshold associated with the plurality of sets of uplink power control parameters.

In some embodiments of the present disclosure, the first transmit power is the lowest one among the corresponding transmit powers of the plurality of sets of uplink power control parameters. The UE may abandon the uplink transmission in response to the channel access procedure being failed (e.g., an energy detected during the channel access procedure is greater than or equal to the first energy detection threshold).

If an energy detected during the channel access procedure is less than the first energy detection threshold, the UE may select another set of uplink power control parameters (hereinafter referred to as “the second set of uplink power control parameters” for illustration) from the plurality of sets of uplink power control parameters. The UE may determine another transmit power (hereinafter referred to as “the second transmit power” for illustration) based on the second set of uplink power control parameters. The second transmit power is higher than the first transmit power. The UE may determine another energy detection threshold (hereinafter referred to as “the second energy detection threshold” for illustration) based on the second transmit power. The UE may transmit the uplink transmission using a previously determined transmit power in response to the second energy detection threshold is less than or equal to the energy detected during the channel access procedure.

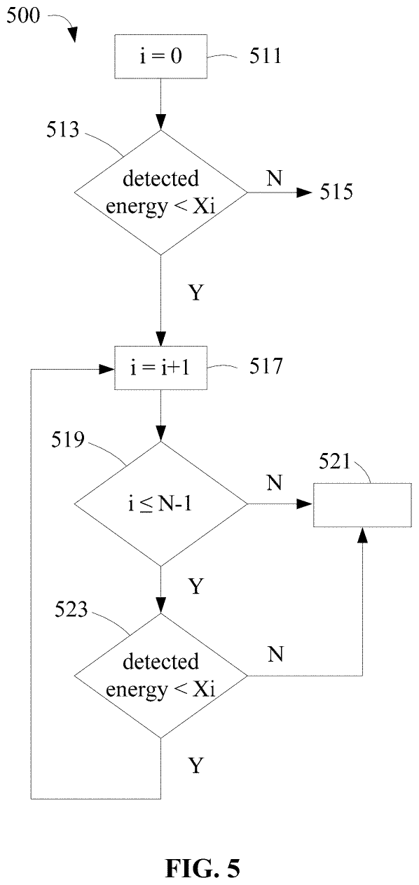

FIG. 5 illustrates a flow chart of an exemplary procedure 500 for determining an energy detection threshold in accordance with some embodiments of the present disclosure.

Assuming that N sets of uplink power control parameters are configured or predefined for a specific traffic type (e.g., URLLC traffic) at the UE, the UE may determine N uplink transmit powers (P₀, P₁, . . . , P_{N-1}) associated with the N sets of uplink power control parameters. Using the above-mentioned equation (2), the UE may obtain N energy detection thresholds (e.g., X₀, X₁, . . . , X_{N-1}). Assuming that P₀<P₁<, . . . , <P_{N-1}, then X₀>X₁>, . . . , >X_{N-1}.

The UE may perform a channel access procedure based on energy detection threshold Xᵢ, wherein i may be one of 1 to N−1. Referring to FIG. 5, in operation 511, the value of i may be set to 0. That is, the UE may perform a channel access procedure based on energy detection threshold X₀, which is the highest energy detection threshold among the N energy detection thresholds and correspond to the lowest transmit powers P₀ among the N uplink transmit powers.

In operation 513, the UE may determine whether the energy detected during the channel access procedure is less than the energy detection threshold Xᵢ (at this moment, i=0). In response to the detected energy is greater than or equal to the energy detection threshold Xᵢ, which means a failed channel access procedure, the UE may abandon the uplink transmission in operation 515.

In response to the detected energy is less than the energy detection threshold Xi, the UE may continue to find another energy detection threshold. For example, the UE may set i=i+1 in operation 517. In operation 519, the UE may determine whether all of the N energy detection thresholds are tested, by, for example, determining whether i is less than or equal to N−1. In response to the value of i is greater than N−1, the procedure may go to operation 521; otherwise, the procedure may go to operation 523. In operation 521, the UE may transmit the uplink transmission using a transmit power (e.g., Pᵢ₋₁) corresponding to a previously energy detection threshold Xᵢ₋₁. For example, i may equal to N, the UE may transmit the uplink transmission using transmit power P_{N-1} corresponding to energy detection threshold X_{N-1}.

In operation 523, the UE may determine whether the energy detected is less than the energy detection threshold Xᵢ. In response to the detected energy is less than the energy detection threshold Xᵢ, the UE may go to operation 517. In response to the detected energy is greater than or equal to the energy detection threshold Xᵢ, the UE may go to operation 521. In operation 521, the UE may transmit the uplink transmission using a transmit power (e.g., Pᵢ₋₁) corresponding to a previously energy detection threshold Xᵢ₋₁.

As mentioned above, the principle of the above procedure is to find out the minimum energy detection threshold which is greater than the detected energy from the plurality of energy detection threshold associated with the plurality of sets of uplink power control parameters.

In some other embodiments of the present disclosure, the UE may determine the first energy detection threshold according to the following method.

In some examples, the UE may receive an RRC message for configuring a plurality of energy detection thresholds. In some other examples, the plurality of energy detection thresholds may be predefined. In some embodiments, the plurality of energy detection thresholds may be configured or predefined in an absolute manner as described above. In some other embodiments, the plurality of energy detection thresholds may be configured or predefined in a relative manner as described above. For example, a plurality of offsets with respect to a default energy detection threshold may be configured by the RRC message or predefined. The default energy detection threshold may be calculated according to an equation (e.g., equation (2) as described above). The UE may select the first energy detection threshold based on certain criteria, for example, a traffic type (e.g., eMBB or URLLC) of an uplink transmission (e.g., PUSCH or PUCCH). In response to the channel access procedure being successful, the UE may transmit the uplink transmission; otherwise, the UE may abandon the uplink transmission.

In yet other embodiments of the present disclosure, the UE may determine the first energy detection threshold according to the following method.

The UE may receive a DCI indicating the first energy detection threshold from a BS. The DCI may include an indicator indicating the first energy detection threshold from a plurality of energy detection thresholds. The plurality of energy detection thresholds may be configured by an RRC message from the BS or may be predefined.

In some embodiments, the plurality of energy detection thresholds may be configured or predefined in an absolute manner as described above. In some other embodiments, the plurality of energy detection thresholds may be configured or predefined in a relative manner as described above. For example, a plurality of offsets with respect to a default energy detection threshold may be configured by the RRC message or predefined. The default energy detection threshold may be calculated according to an equation (e.g., equation (2) as described above).

In response to the channel access procedure being successful, the UE may transmit the uplink transmission; otherwise, the UE may abandon the uplink transmission.

In yet other embodiments of the present disclosure, the UE may determine the first energy detection threshold according to the following method.

The UE may receive a DCI indicating a set of uplink power control parameters (hereinafter referred to as “the first set of uplink power control parameters” for illustration) from a plurality of sets of uplink power control parameters. The UE may determine a transmit power (hereinafter referred to as “the first transmit power” for illustration) for an uplink transmission (e.g., PUSCH or PUCCH) based on the first set of uplink power control parameters. The first energy detection threshold may be determined based on the first transmit power. The plurality of sets of uplink power control parameters may be configured by an RRC message from the BS or may be predefined. In response to the channel access procedure being successful, the UE may transmit the uplink transmission; otherwise, the UE may abandon the uplink transmission.

As mentioned above, in the context of the subject disclosure, performing a channel access procedure based on the specific energy detection threshold (e.g., the first energy detection threshold) refers to performing the channel access procedure using an energy detection threshold less than or equal to the specific energy detection threshold.

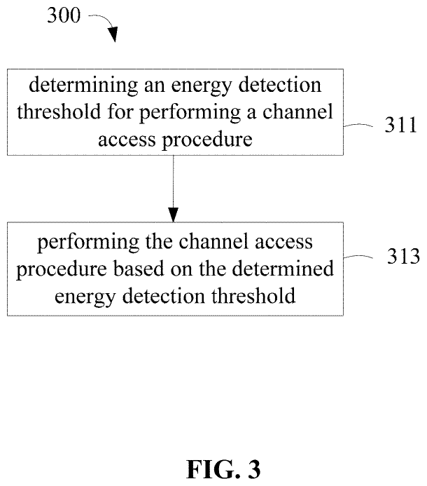

FIG. 3 illustrates a flow chart of an exemplary procedure 300 for wireless communications in accordance with some embodiments of the present disclosure. Details described in all of the foregoing embodiments of the present disclosure are applicable for the embodiments shown in FIG. 3. The procedure may be performed by a UE, for example, BS 102 in FIG. 1.

Referring to FIG. 3, in operation 311, a BS may determine an energy detection threshold for performing a channel access procedure. The energy detection threshold may be determined from a plurality of energy detection thresholds based on certain criteria, for example, a traffic type (e.g., eMBB or URLLC) of a downlink transmission (e.g., PDSCH or PDCCH). In operation 311, the BS may perform the channel access procedure based on the determined energy detection threshold.

In some embodiments of the present disclosure, the plurality of energy detection thresholds may be predefined. In some examples, the plurality of energy detection thresholds may be predefined in an absolute manner as described above. In some other examples, the plurality of energy detection thresholds may be predefined in a relative manner as described above. For example, a plurality of offsets with respect to a default energy detection threshold may be predefined. The default energy detection threshold may be calculated according to an equation (e.g., equation (2) as described above).

As mentioned above, in the context of the subject disclosure, performing a channel access procedure based on the specific energy detection threshold (e.g., the energy detection threshold determined in operation 311) refers to performing the channel access procedure using an energy detection threshold less than or equal to the specific energy detection threshold.

It should be appreciated by persons skilled in the art that the sequence of the operations in exemplary procedures 200-500 may be changed and some of the operations in exemplary procedures 200-500 may be eliminated or modified, without departing from the spirit and scope of the disclosure.

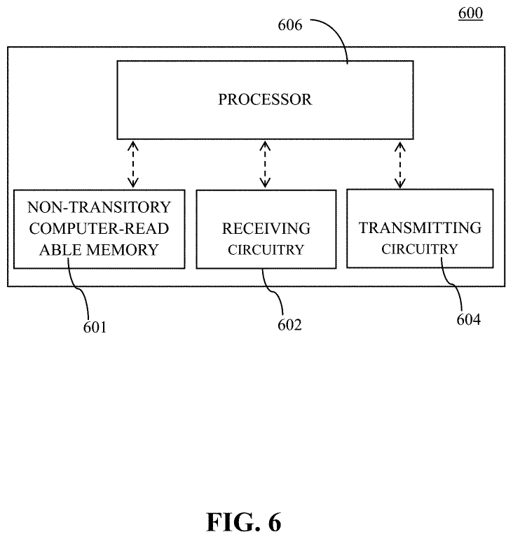

FIG. 6 illustrates a block diagram of an exemplary apparatus 600 in accordance with some embodiments of the present disclosure.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The apparatus 600 may be a base station side apparatus (e.g., a BS) or a communication device (e.g., a UE).

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 are combined into a single device, such as a transceiver. In certain embodiments of the present application, the apparatus 600 may further include an input device, a memory, and/or other components.

In some embodiments of the present disclosure, the non-transitory computer-readable medium 601 may have stored thereon computer-executable instructions to cause a processor to implement the method with respect to the UEs as described above. For example, the computer-executable instructions, when executed, cause the processor 606 interacting with receiving circuitry 602 and transmitting circuitry 604, so as to perform the operations with respect to the UEs described in FIGS. 1, 2, 4 and 5.

In some embodiments of the present disclosure, the non-transitory computer-readable medium 601 may have stored thereon computer-executable instructions to cause a processor to implement the method with respect to the BSs as described above. For example, the computer-executable instructions, when executed, cause the processor 606 interacting with receiving circuitry 602 and transmitting circuitry 604, so as to perform the operations with respect to the BSs described in FIGS. 1-3.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including.” The wording such as “the first” and “the second” and the like is only used to clearly illustrate the embodiments of the present application, but not be used to limit the substance of the present application.

1-32. (canceled)

33. User equipment (UE), comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to implement a method for wireless communications, the method comprising:
determining a first energy detection threshold for performing a channel access procedure; and
performing the channel access procedure based on the first energy detection threshold.

34. The UE of claim 33, further comprising:
determining a first transmit power for an uplink transmission, wherein the first energy detection threshold is determined based on the first transmit power.

35. The UE of claim 34, wherein the first transmit power is determined based on a first set of uplink power control parameters.

36. The UE of claim 35, wherein the first set of uplink power control parameters is selected from a plurality of sets of uplink power control parameters based on a traffic type of the uplink transmission.

37. The UE of claim 36, wherein the plurality of sets of uplink power control parameters is configured by a radio resource control (RRC) message or is predefined.

38. The UE of claim 36, wherein each of the plurality of sets of uplink power control parameters is associated with a corresponding transmit power, and the first transmit power is the highest one among the corresponding transmit powers of the plurality of sets of uplink power control parameters.

39. The UE of claim 38, further comprising:
transmitting the uplink transmission using the first transmit power in response to the channel access procedure being successful.

40. The UE of claim 38, further comprising:
in response to the channel access procedure being failed, selecting a second set of uplink power control parameters from the plurality of sets of uplink power control parameters;
determining a second transmit power based on the second set of uplink power control parameters, wherein the second transmit power is lower than the first transmit power;
determining a second energy detection threshold based on the second transmit power.

41. The UE of claim 38, further comprising:
transmitting the uplink transmission using the second transmit power in response to the second energy detection threshold is greater than an energy detected during the channel access procedure.

42. The UE of claim 36, wherein each of the plurality of sets of uplink power control parameters is associated with a corresponding transmit power, and the first transmit power is the lowest one among the corresponding transmit powers of the plurality of sets of uplink power control parameters.

43. The UE of claim 33, wherein the first energy detection threshold is determined from a plurality of energy detection thresholds based on a traffic type of an uplink transmission.

44. The UE of claim 33, further comprising:
receiving downlink control information (DCI) indicating the first energy detection threshold.

45. The UE of claim 33, wherein performing the channel access procedure based on the first energy detection threshold comprises performing the channel access procedure using an energy detection threshold less than or equal to the first energy detection threshold.

46. A base station (BS), comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to implement a method for wireless communications, the method comprising:
determining an energy detection threshold for performing a channel access procedure, wherein the energy detection threshold is determined from a plurality of energy detection thresholds based on a traffic type of a downlink transmission; and
performing the channel access procedure based on the determined energy detection threshold.

47. The BS of claim 46, wherein the plurality of energy detection thresholds is predefined.

48. The BS of claim 46, wherein the plurality of energy detection thresholds is determined based on a plurality of offsets with respect to a default energy detection threshold.

49. The BS of claim 48, wherein the plurality of offsets is predefined.

50. The BS of claim 46, wherein the traffic type of the downlink transmission comprises enhanced Mobile Broadband (eMBB) or Ultra-Reliable and Low Latency Communications (URLLC).

51. The BS of claim 46, wherein performing the channel access procedure based on the determined energy detection threshold comprises performing the channel access procedure using an energy detection threshold less than or equal to the determined energy detection threshold.

52. A method performed by user equipment (UE), the method comprising:
determining a first energy detection threshold for performing a channel access procedure; and
performing the channel access procedure based on the first energy detection threshold.
